(19) United States
(12) Patent Application Publication
(10) Pub. No.: US 2026/0025487 A1
(43) Pub. Date: Jan. 22, 2026

(54) LIGHT SOURCE MODULE

(71) Applicant: Nippon Seiki Co.,Ltd., Niigata (JP)

(72) Inventors: Shigeru Kojima, Niigata (JP); Katsuhiko Tanimoto, Niigata (JP)

(21) Appl. No.: 19/251,258

(22) Filed: Jun. 26, 2025

(30) Foreign Application Priority Data
Jul. 22, 2024 (JP) 2024-116704

(51) Int. Cl. H04N 9/31; G03B 21/20

(52) U.S. Cl. CPC H04N 9/3161; G03B 21/2066; H04N 9/3144

(57) ABSTRACT

Provided is a technique by which it is possible to reduce a volume of a moisture-proof space for sealing a light source module against moisture. A light source module includes a first laser that emits red light, a second laser that emits green light, a third laser that emits blue light, an electronic cooling module that adjusts a temperature of the first laser, a first case that houses the first laser, and a second case that houses the second laser and the third laser.

### TECHNICAL FIELD

The present invention relates to a technique for improving a light source module.

### BACKGROUND ART

A light source module is used in various types of image display devices. An example of a known technique for such a light source module includes a technique disclosed in Patent Document 1.

In the technique disclosed in Patent Document 1, a laser light source unit includes a light source module (light source unit) that combines and emits laser light, and an optical system (projection unit) that projects laser light emitted from the light source module. In an image display device or the like such as a projector displaying an object in color, lasers with three colors including red, blue, and green are used, and because of the light emission characteristics of such lasers changing with a temperature, it may be necessary to perform forced cooling using an electronic cooling module such as a Peltier element. When the forced cooling is provided, a cooled part is cooled to a temperature at or below a dew point, and thus, the laser and other components are sealed against moisture to trap dry air so that the laser and other components do not condense. In the technique disclosed in Patent Document 1, the entire light source module including the lasers with three colors including red, blue, and green is housed in a single enclosed housing. The entire light source module is therefore sealed against moisture.

### PRIOR ART DOCUMENT

### Patent Document

Patent Document 1: JP 6606633 B1

### SUMMARY OF INVENTION

### Technical Problem

However, in the technique disclosed in Patent Document 1, as the three lasers are larger, a moisture-proof space within the housing is also inevitably larger. If the moisture-proof space is large, a large force is applied to a sealing member due to fluctuations in the internal pressure of the moisture-proof space caused by temperature changes, and a large amount of water vapor remains in the sealed space. Thus, it is necessary to reduce the sealed space.

The present invention has been made to solve the above problems, and an object of the present invention is to provide a technique by which it is possible to reduce a volume of a moisture-proof space for sealing a light source module against moisture.

### Solution To Problem

A light source module according to a first aspect includes a first laser that emits red light, a second laser that emits green light, a third laser that emits blue light, an electronic cooling module that adjusts a temperature of the first laser, a first case that houses the first laser, and a second case that houses the second laser and the third laser.

In the light source module according to a second aspect, which may be dependent on the first aspect, the second case includes a moisture permeable portion capable of transmitting water vapor.

In the light source module according to a third aspect, which may be dependent on the first or second aspect, the first case includes a transmissive portion that transmits the red light and is capable of enclosing an inside of the first case, and the transmissive portion is arranged to transmit the red light to enter the second case.

In the light source module according to a fourth aspect, which may be dependent on the third aspect, the second case includes a dichroic mirror that combines the green light, the blue light, and the red light, the dichroic mirror is arranged on an optical path of the red light entering through the transmissive portion and is tilted with respect to an incident direction of the red light, a direction in which the red light is reflected by the dichroic mirror and travels is defined as a first direction, and an opposite direction to the first direction is defined as a second direction, and the transmissive portion is tilted with respect to the dichroic mirror so that an end in the first direction is spaced farther away than an end in the second direction.

In the light source module according to a fifth aspect, which may be dependent on the first to fourth aspects, the light source module further includes a first heat sink that dissipates heat from the electronic cooling module and a second heat sink that dissipates heat from the second laser and the third laser, and the first heat sink and the second heat sink are arranged with a gap between the first heat sink and the second heat sink.

In the light source module according to a sixth aspect, which may be dependent on the fifth aspect, the light source module further includes an air-cooling fan that draws in air so that the air flows through the second heat sink and the first heat sink in the stated order, and the air-cooling fan is provided on an end face of the first heat sink opposite to the second heat sink.

### Advantageous Effects of Invention

According to the present invention, it is possible to reduce a volume of a moisture-proof space for sealing a light source module against moisture.

### BRIEF DESCRIPTION OF DRAWINGS

FIG. 1A is an external view of an image display device including a light source module according to an example, and FIG. 1B is a circuit diagram of the image display device illustrated in FIG. 1A.

FIG. 2 is a cross-sectional view of the light source module illustrated in FIG. 1A.

FIG. 3 is an enlarged view of part 3 of FIG. 2.

### DESCRIPTION OF EMBODIMENTS

An embodiment of the present invention will be described below with reference to the accompanying drawings. The best embodiment described below is used to facilitate understanding of the present invention. Therefore, those skilled in the art should note that the present invention is not unduly limited by the embodiment described below.

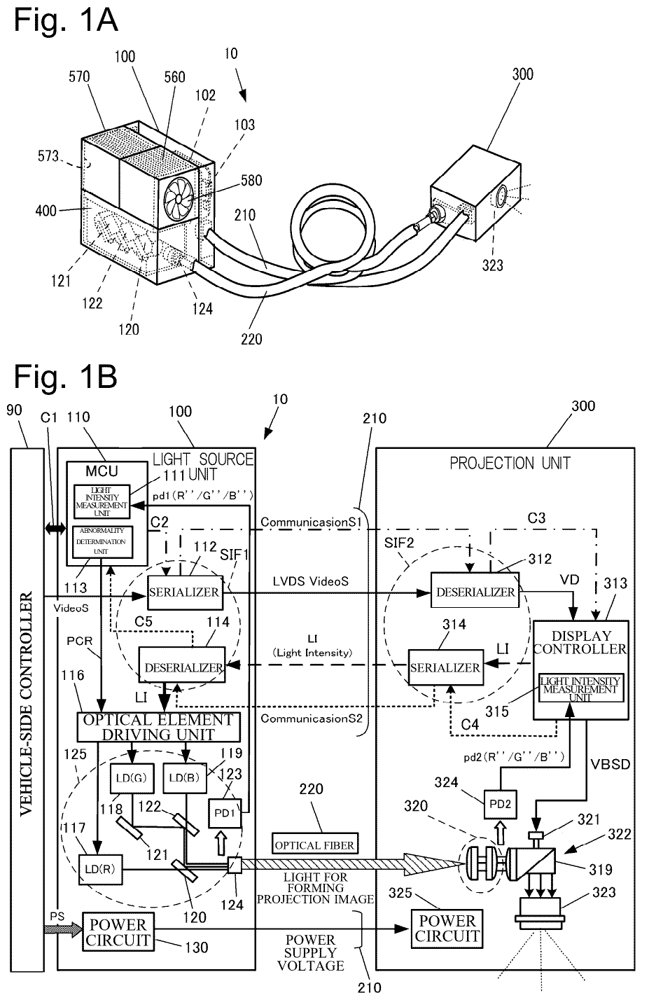

FIGS. 1A and 1B illustrate an example of an external appearance of an image display device 10 and an example of an internal configuration of a light source unit 100 and a projection unit 300, respectively. In the examples of FIGS. 1A and 1B, the image display device 10 is an in-vehicle projection type display system (in-vehicle projector) to be mounted in a vehicle (not illustrated). However, the image display device 10 according to the present invention is not limited to the in-vehicle projection type display system to be mounted in a vehicle (not illustrated).

In recent years, there has been a demand for image display devices (in-vehicle projection type display systems) with higher luminance to improve visibility. However, for the light source to emit brighter light, it is necessary to efficiently dissipate heat generated in the light source, and there is a tendency that a heat sink or the like for dissipating heat increases in size. As a result, a case is assumed in which the image display device may be too large to be mounted in a limited space such as a vehicle.

Therefore, in the present invention, the light source unit 100 and the projection unit 300 are separated using an optical transmission technique using an optical fiber cable 220, and the image display device 10 (in-vehicle projection type display system 10) including the light source unit 100 and the projection unit 300 separately is provided. Hereinafter, the light source unit 100 may be referred to as a “light source module 100”. The optical fiber cable 220 may be simply referred to as an “optical fiber 220”. If the light source unit 100 and the projection unit 300 are separated, the light source unit 100 having a large amount of dissipated heat can be placed in any available space where the light source unit 100 can be mounted in a vehicle or the like while the projection unit 300 that forms a projected image can be separated from a heat source and freely placed at an appropriate location, as a result, it is easier to mount the image display device 10 in a vehicle.

On the other hand, after attaching the light source unit 100 and the projection unit 300 in an available space in a vehicle or the like, the image display device 10 needs a task for connecting the light source unit 100 and the projection unit 300 with a communication cable 210 and the optical fiber 220. After such a task, it is necessary to determine whether the image display device 10 operates normally, and if an abnormal state is detected, it is necessary to take appropriate measures such as stopping outputting light and reporting the abnormality. However, the amount of light transmitted through the optical fiber 220 may vary greatly depending on the wiring conditions of the optical fiber 220, the environmental temperature, and the like, and under such circumstances, it is not easy to determine whether the image display device 10 is normal or abnormal based solely on the light receiving intensity at a light receiving unit 324 provided on a side of the projection unit 300.

Therefore, in the present embodiment, a light receiving unit 123 is also provided on a side of the light source unit 100, and information on the light receiving intensity obtained from the light receiving unit 123 and actually measured and information on the light receiving intensity obtained from the light receiving unit 324 on the side of the projection unit 300 and actually measured are obtained. Each piece of information can be used to perform an abnormality determination process in a predetermined procedure to detect abnormalities in the projection type display system 10 caused by the wiring conditions of the optical fiber 220, the environmental temperature, and the like.

A specific description will be provided below with reference to the drawings.

As illustrated in FIG. 1A, in the image display device 10, the light source unit 100 and the projection unit 300 are arranged separately, and the light source unit 100 and the projection unit 300 are electrically connected via the communication cable 210. Light for forming a projection image output by the light source unit 100 is supplied to the projection unit 300 via the optical fiber 220, and the projection image is formed by the projection unit 300. The communication cable 210 can be used to transmit a power source, a control signal, a video signal, and the like.

The light source unit 100 includes a control board 102, an integrated circuit device 103 including a microcontroller 110 (MCU 110: see FIG. 1B) serving as a first control unit mounted on the control board 102, a plurality of mirrors 120 to 122 serving as an optical element, and the like. On the other hand, the projection unit 300 has a projection aperture (emission aperture) 323 and the like through which display light for an image is projected (emitted).

As illustrated in FIG. 1B, the light source unit 100 includes the MCU 110 serving as a first control unit, a serializer 112 (parallel/serial converter), a deserializer 114 (parallel/serial converter), an optical element driving unit 116 (LC driver), a plurality of optical elements 117 to 119 having different light colors (here, laser diodes corresponding to colors including R (red), G (green), and B (blue)), the plurality of mirrors 120 to 122, the first light receiving unit 123 (here, a first photodiode PD1 is used) that detects the light intensity of light for forming a projection image of each color output from the light source unit 100, a light output interface 124, and a power circuit 130 (power supply circuit).

The MCU 110 is an integrated circuit device in which a processor functioning as a main CPU (host CPU) and peripheral circuits such as a memory are integrated.

The MCU 110 includes a first light intensity measurement unit 111 that measures light intensity based on actually measured values (pd1(R″/G″/B″)) of light with each color including red (R), green (G), and blue (B), sent from the first light receiving unit (PD1) 123, and an abnormality determination unit 113.

An optical element unit 125 includes the plurality of optical elements 117 to 119 having different emission colors, the plurality of mirrors 120 to 122, the first light receiving unit (first photodiode PD1) 123, and the light output interface 124.

A first serial interface unit SIF1 includes the serializer 112 and the deserializer 114.

The projection unit 300 includes a deserializer (serial/parallel converter) 312, a display controller (display control device) 313 serving as a second control unit, a serializer (parallel/serial converter) 314, a light input interface 320, an optical modulation device (here, a digital mirror device (DMD) is used) 322, a second light receiving unit (here, a second photodiode PD2 is used) 324 that detects the light intensity of each color of light for forming a projection image sent via the optical fiber 220, and a power circuit (power supply circuit) 325.

The display controller 313 is a dedicated integrated circuit device that is mounted with a sub-CPU (not illustrated) and performs display control in place of the MCU 110.

The display controller 313 includes a second light intensity measurement unit 315 that measures light intensity, based on the actually measured values of light of each color including R, G, and B (pd2(R″/G″/B″)) sent from the second light receiving unit (PD2) 324.

A second serial interface unit SIF2 includes the deserializer 312 and the serializer 314.

The optical modulation device 322 includes a main body portion 319 built with an optical modulation element therein, an input terminal 321 of the optical modulation device 322 to which video bitstream data VBSD supplied from the display controller 313 is input, and the projection aperture 323 for projecting display light of an image.

The light input interface 320 receives light for forming a projection image transmitted from the light source unit 100 via the optical fiber 220, and supplies the received light (light with each color including R, G, and B) to the main body portion 319 of the optical modulation device 322.

Next, the contents of communication of a video signal and a control signal passing through the first serial interface unit SIF1 and the second serial interface unit SIF2 will be described.

Examples of serial communication signals transmitted and received between the first serial interface unit SIF1 and the second serial interface unit SIF2 include a serial video signal (LVDS VideoS) transmitted from the light source unit 100 to the projection unit 300 using the Low Voltage Differential Signal (LVDS) transmission method, a light emission enable signal (LDE: specifically, LEDR/G/B LD Enable for each color) which is a signal that allows the optical elements 117 to 119 to emit light and is transmitted from the light source unit 100 to the projection unit 300, and various types of communication signals (CommunicationS1 CommunicationS2).

Next, an example of the various types of communication signals will be described. For example, a vehicle-side controller 90 mounted in a vehicle (not illustrated) can transmit various types of request commands Cl based on user settings to the MCU 110 of the light source unit 100.

Examples of the request commands include request commands to instruct to change the display brightness, change the color balance, change the video size, change the video position, correct the projection distortion, turn display on/off, and the like.

The MCU 110 sends the received request command as a communication signal C2 to the serializer 112, and the serializer 112 performs parallel/serial conversion on the received communication signal C2 to generate the communication signal CommunicationS1, and transmits the communication signal CommunicationS1 to the projection unit 300 via the communication cable 210. The deserializer 312 of the projection unit 300 performs serial/parallel conversion on the received communication signal CommunicationS1 to generate a communication signal C3, and sends the communication signal C3 to a display controller (second control unit) 313.

The display controller 313 performs processing in response to various types of requests from the MCU 110 of the light source unit 100, and generates a signal C4 indicating the result of the performed processing (for example, a signal indicating that the processing is successful, or a signal indicating the parameter value obtained as a result of the processing) and sends the signal C4 to the serializer 314. The serializer 314 performs parallel/serial conversion on the communication signal C4 to generate the communication signal CommunicationS2, and transmits the communication signal CommunicationS2 to the light source unit 100 via the communication cable 210. The deserializer 114 of the light source unit 100 performs serial/parallel conversion on the received communication signal CommunicationS2 to generate a communication signal C5, and sends the communication signal C5 to the MCU 110.

Thus, the MCU 110 and the display controller 313 can transmit and receive various types of signals via the first and second serial interface units SF1 and SF2.

Next, the transmission of the video signal will be described. The vehicle-side controller 90 transmits the video signal VideoS to the serializer 112 of the light source unit 100. The serializer 112 generates an LVDS format video signal LVDS VideoS, based on the received video signal VideoS and transmits such a signal to the projection unit 300 via the communication cable 210. The deserializer 312 of the projection unit 300 converts the received LVDS format video signal LVDS VideoS into a parallel format video digital signal VD and sends the video digital signal VD to the display controller 313.

Next, a flow of signals for the abnormality determination process will be described. The display controller 313 can transmit the actually measured value (pd2) in the second light intensity measurement unit 315 to the light source unit 100 as light intensity information LI.

The light intensity information LI delivered from the display controller 313 is subjected to parallel/serial conversion by the serializer 314 and transmitted to the light source unit 100 as the light intensity information LI (Light Intensity) in a serial format.

The deserializer 114 of the light source unit 100 performs serial/parallel conversion on the received light intensity information LI in a serial format and transmits the light intensity information LI as the communication signal C5 to the MCU 110 (more specifically, the abnormality determination unit 113), and collaterally supplies the light intensity information LI to the optical element driving unit 116.

The abnormality determination unit 113 receiving the light intensity information LI executes predetermined processing using the actually measured value (pd2) at the second light receiving unit 324 (PD2) of the projection unit 300, and if necessary, generates a light source drive value control signal PCR and sends the signal to the optical element drive unit 116 to appropriately control the light emission intensity of the optical elements 117 to 119 of each color.

The optical element driving unit 116 finely adjusts the light emission intensity of the optical elements 117 to 119 of each color so that the variation in the sent light intensity information LI (actually measured values (pd2) in the second light receiving unit (PD2)) within a predetermined period falls within a predetermined level. This implements APC (Automatic Power Control) to stabilize the light output of the plurality of optical elements 117 to 119 that emit different light colors.

The vehicle-side controller 90 supplies a power source PS to the power circuit 130 of the light source unit 100. The power circuit 130 supplies a power supply voltage to a power circuit 325 of the projection unit 300 via the communication cable 210. The power circuit 325 supplies a power supply voltage to each component in the projection unit 300.

As described above, each of the optical elements 117 to 119 is formed of a laser diode (also called laser). Hereinafter, the optical element 117 configured to emit red light (R) may be referred to as the “first laser 117”, the optical element 118 configured to emit green light (G) as the “second laser 118”, and the optical element 119 configured to emit blue light (B) as the “third laser 119”. The light emission directions of all the lasers 117 to 119 are the same.

Among the plurality of mirrors 120 to 122, the mirror 120 reflecting red light (R) emitted from the first laser 117 may be referred to as the “first mirror 120”, the mirror 121 reflecting green light (G) emitted from the second laser 118 may be referred to as the “second mirror 121”, and the mirror 122 reflecting blue light (B) emitted from the third laser 119 may be referred to as the “third mirror 122”.

Next, a housing structure and a cooling structure for the plurality of lasers 117 to 119 will be described with reference to FIGS. 1A, 2 and 3.

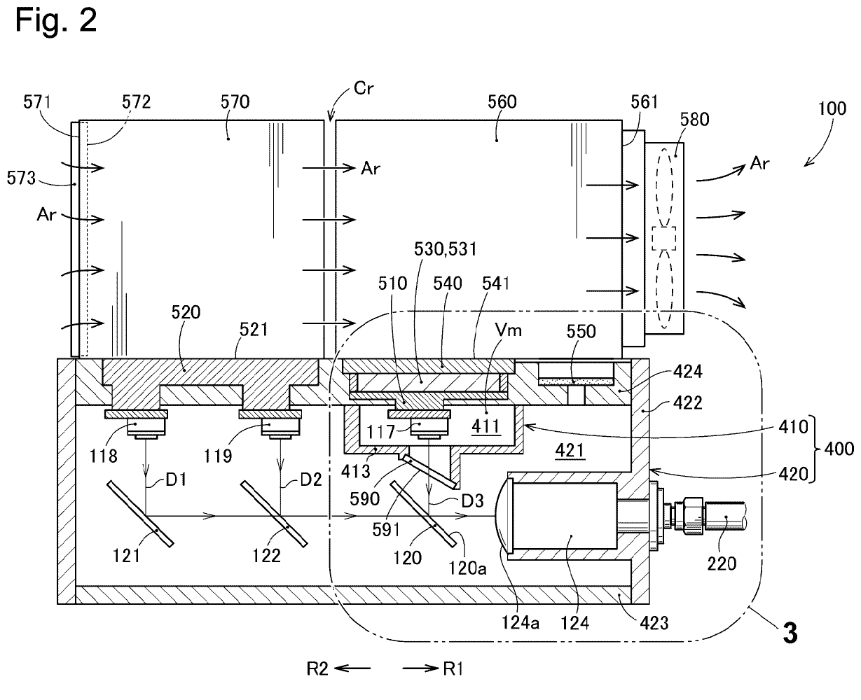

As illustrated in FIG. 2, the second mirror 121 reflects the green light emitted from the second laser 118. The second mirror 121 is placed on the optical path of the green light emitted from the second laser 118 while being tilted with respect to the incident direction

DI of the green light.

The third mirror 122 transmits the green light emitted from the second laser 118 and reflected by the second mirror 121 while reflecting the blue light emitted from the third laser 119. The third mirror 122 is placed on the optical path of the blue light emitted from the third laser 119 while being tilted with respect to the incident direction D2 of the blue light.

The first mirror 120 transmits the green light emitted from the second laser 118 and the blue light emitted from the third laser 119 while reflecting the red light emitted from the first laser 117. That is, the first mirror 120 is configured as a dichroic mirror that combines green light, blue light, and red light. The first mirror 120 may be referred to as the “dichroic mirror 120” as appropriate. The dichroic mirror 120 is placed on the optical path of the red light emitted from the first laser 117 while being tilted with respect to an incident direction D3 of the red light and facing a light receiving surface 124a of the light output interface 124.

All of the mirrors 120 to 122 and the light output interface 124 are located on the same optical axis (on the same line). The second mirror 121 and the third mirror 122 are tilted in the same direction as the first mirror 120. Therefore, the light output interface 124 can receive light emitted from each of the lasers 117 to 119.

Here, a direction R1 in which the red light emitted from the first laser 117 travels after being reflected by the first mirror 120 (dichroic mirror 120) is referred to as a “first direction R1”. The opposite direction R2 to the first direction RI is referred to as the “second direction R2”.

The second mirror 121 that reflects green light, the third mirror 122 that reflects blue light, and the first mirror 120 that reflects red light are arranged in this order in the first direction R1, that is, toward the light receiving surface 124a of the light output interface 124. Correspondingly, the second laser 118 that emits green light, the third laser 119 that emits blue light, and the first laser 117 that emits red light are also arranged in this order in the first direction R1.

The lasers 117 to 119, the mirrors 120 to 122, and the light output interface 124 are housed in a case 400. The case 400 includes a first case 410 that houses only the first laser 117, and a second case 420 that houses the second and third lasers 118 and 119. The second case 420 further houses all of the mirrors 120 to 122 and the light output interface 124. An internal space 421 (second storage space 421) of the second case 420 is sealed against dust.

In general, the first laser 117 dissipates more heat than the second and third lasers 118 and 119. Thus, the temperature of the first laser 117 is adjusted by an electronic cooling module 530. The electronic cooling module 530 preferably includes a Peltier element 531 (Peltier module 531) that is small and lightweight and easily controls a temperature of small components such as a laser.

When the temperature of the first laser 117 is adjusted, if a portion of the first laser 117 that should be cooled is exposed to humid air, condensation may occur, as a result, a normal operation of the first laser 117 may be inhibited. In particular, water vapor molecules are smaller than dust particles. To address such a situation, an internal space 411 (first storage space 411) of the first case 410 is sealed against moisture. If the internal space 411 is sealed against moisture, it is possible to ensure higher airtightness (sealability) than in a case where the internal space 411 is sealed against dust. Dry air is trapped in the first storage space 411 sealed against moisture.

The first storage space 411 is highly airtight due to sealing against moisture. Moreover, it is sufficient that the first case 410 accommodates only the first laser 117, and thus, the first case 410 is extremely small in size. Therefore, a volume Vm of the first storage space 411 (moisture-proof space 411) to be sealed against moisture can be made as small as possible. This is extremely advantageous in sealing against moisture for the first storage space 411.

As illustrated in FIG. 1A, the control board 102 and the integrated circuit device 103 are provided with sealed against dust on the side of the case 400, but may be housed in the second storage space 421 of the second case 420.

A configuration of the case 400 will be described in detail.

First, the second case 420 will be described. As illustrated in FIG. 2, the second case 420 is a rectangular box and is configured to be sealed against dust by a frame-shaped case body 422 penetrating from top to bottom, a flat plate-like bottom plate 423 (first plate 423) covering one opening of the case body 422, and a flat plate-like top plate 424 (second plate 424) covering the other opening of the case body 422. The light output interface 124 is attached to the side of the case body 422.

A first heat dissipation plate 510 and a second heat dissipation plate 520 are attached to the top plate 424 of the second case 420.

A portion of the first heat dissipation plate 510 protrudes from the top plate 424 into the first storage space 411, and the first laser 117 is provided in close contact with the portion of the first heat dissipation plate 510. The electronic cooling module 530 and a sealing plate 540 are laminated in this order and affixed to the surface of the first heat dissipation plate 510 opposite to the first laser 117. One end face 541 of the sealing plate 540 is a flat exposed surface exposed from the top plate 424. At least one of the first heat dissipation plate 510, the electronic cooling module 530, and the sealing plate 540 is sealed against moisture to the top plate 424. One example of a configuration for sealing against moisture includes a sealing structure using a sealing member (not illustrated) such as a highly airtight adhesive or packing.

A portion of the second heat dissipation plate 520 protrudes from the top plate 424 into the second storage space 421, and the second and third lasers 118 and 119 are provided individually and in close contact with each other. A surface 521 (one end face 521) of the second heat dissipation plate 520 opposite to the second and third lasers 118 and 119 is a flat exposed surface exposed from the top plate 424.

Thus, all the lasers 117 to 119 are arranged in a row on the inner surface of the top plate 424 (the surface on a side of the second storage space 421).

The second case 420 includes a moisture permeable portion 550 capable of transmitting water vapor generated in the second storage space 421 and capable of preventing the transmission of moisture. The moisture permeable portion 550 has both a waterproof property to prevent the intrusion of moisture from the outside and moisture permeability to allow moisture from the second storage space 421 to pass through, and includes, for example, a moisture permeable and waterproof sheet. The water vapor in the second storage space 421 is dissipated to the outside through the moisture permeable portion 550.

The water vapor tends to rise within the second storage space 421, and thus, to increase the moisture permeability of the moisture permeable portion 550, it is preferable to provide the moisture permeable portion 550 at the upper end of the second case 420, for example, on the top plate 424. To prevent moisture from entering the second storage space 421 from the outside through the moisture permeable portion 550, it is preferable to provide the moisture permeable portion 550 at the upper end of the second case 420 and below a first heat sink 560 described later.

The light source module 100 includes the first heat sink 560 that dissipates heat from the first laser 117, a second heat sink 570 that dissipates heat from the second laser 118 and the third laser 119, and an air-cooling fan 580 that dissipates heat from the first and second heat sinks 560 and 570 into the atmosphere.

The first heat sink 560 and the second heat sink 570 are placed along the plate surface of the top plate 424 with a gap Cr therebetween, and are attached to the second case 420. With the gap Cr between the first heat sink 560 and the second heat sink 570, an air layer exists in the gap Cr. With such an air layer, it is possible to prevent heat transfer between the first heat sink 560 and the second heat sink 570 as much as possible.

The first heat sink 560 overlaps the entire surface of the sealing plate 540 in a heat-transferable manner. Therefore, heat from the electronic cooling module 530 can be dissipated to the first heat sink 560. The second heat sink 570 overlaps the entire surface of the second heat dissipation plate 520 in a heat-transferable manner. Therefore, heat from the second laser 118 and the third laser 119 can be dissipated to the second heat sink 570. The first heat sink 560 and the second heat sinks 570 include, for example, a plate fin heat sink, a pin fin heat sink, or a corrugated fin heat sink.

An air intake port 572 is provided on an end face 571 of the second heat sink 570 opposite to the first heat sink 560. The air intake port 572 is provided with a dust-proof filter 573 such as a wire mesh.

The air-cooling fan 580 is provided on an end face 561 of the first heat sink 560 opposite to the second heat sink 570, and sucks in outside air Ar (air Ar) taken in through the air intake port 572 so that the outside air Ar flows through the second heat sink 570 and the first heat sink 560 in the stated order.

The outside air Ar (air Ar) sucked in by the air-cooling fan 580 passes through the dust-proof filter 573 and enters the second heat sink 570 from the air intake port 572. The heat generated by the second and third lasers 118 and 119 is transferred from the second heat dissipation plate 520 to the second heat sink 570 and dissipated by heat exchange with the air Ar. The air Ar passing through the second heat sink 570 enters the first heat sink 560.

The heat generated by the first laser 117 is transmitted from the first heat dissipation plate 510 to the electronic cooling module 530 and dissipated, and then transmitted from the electronic cooling module 530 through the sealing plate 540 to the first heat sink 560, and is further dissipated by heat exchange with the air Ar. The air Ar passing through the first heat sink 560 is dissipated into the atmosphere by the air-cooling fan 580.

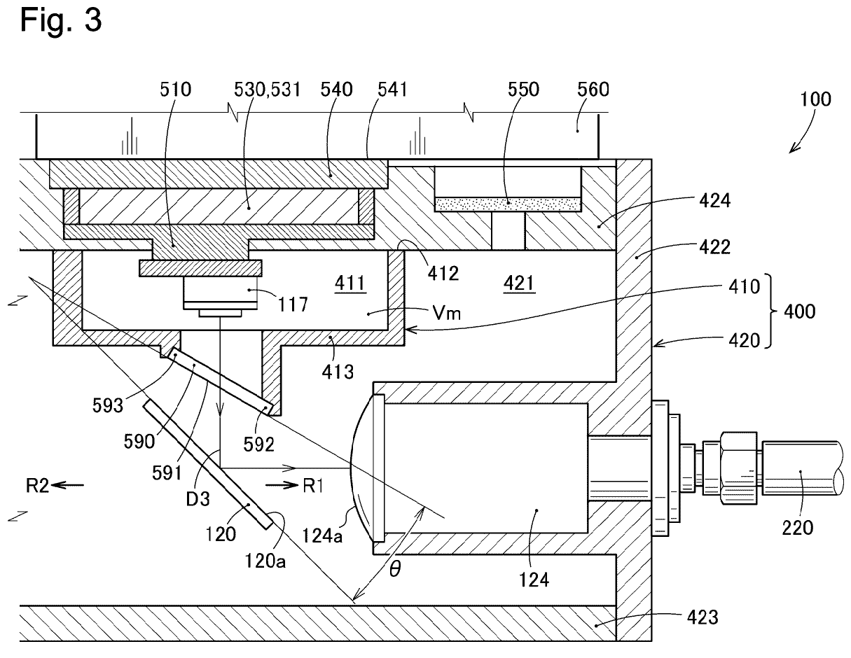

Next, the first case 410 will be described. As illustrated in FIG. 3, it is preferable for the purpose of miniaturizing and integrating the case 400 that the first case 410 is housed in the second case 420 including the first laser 117. Thus, the first case 410 is configured to cover the first laser 117 arranged on the top plate 424 of the second case 420 to seal against moisture.

To describe in detail, the first case 410 is a rectangular box, and is provided integrally with the top plate 424 of the second case 420. That is, only the upper end 412 of the first case 410 is open. The open upper end 412 is closed by the top plate 424 to seal against moisture. One example of a configuration for sealing against moisture includes a sealing structure using a sealing member (not illustrated) such as a highly airtight adhesive or packing. A bottom plate 413 of the first case 410 is a flat plate-like portion facing a bottom plate 423 of the second case 420 and a reflecting surface 120a of the first mirror 120.

The first case 410 includes a transmissive portion 590 to transmit the red light emitted from the first laser 117 housed in the first storage space 411 through the first case 410 to the first mirror 120. The transmissive portion 590 is placed to transmit the red light emitted from the first laser 117 from the first case 410 and enter the second case 420 (the second storage space 421). More specifically, the transmissive portion 590 is a flat plate-like member such as a transparent glass plate provided on the bottom plate 413 of the first case 410, and is sealed against moisture with respect to the first case 410. One example of a configuration for sealing against moisture includes a sealing structure using a sealing member (not illustrated) such as a highly airtight adhesive or packing. As is clear from the above description, the first case 410 is entirely sealed against moisture.

The first mirror 120 is placed on the optical path of the red light emitted from first laser 117 and transmitted through the transmission portion 590 and is incident thereon, and is tilted with respect to an incident direction D3 of the red light. A transmitting surface 591 of the transmissive portion 590 is a flat surface facing the reflecting surface 120a of the first mirror 120. The transmitting surface 591 of the transmissive portion 590 is tilted relative to the reflecting surface 120a of the first mirror 120 so that an end 592 in the first direction RI is farther away than an end 593 in the second direction R2. That is, the transmitting surface 591 of the transmissive portion 590 widens relative to the reflecting surface 120a of the first mirror 120 as the transmitting surface 591 approaches the light receiving surface 124a of the light output interface 124 (as the transmitting surface 591 moves in the first direction R1). θ denotes the opening angle of the transmitting surface 591 of the transmissive portion 590 with respect to the reflecting surface 120a of the first mirror 120.

The above explanation is summarized as follows.

As illustrated in FIG. 2, the light source module 100 includes the first laser 117 that emits red light, the second laser 118 that emits green light, the third laser 119 that emits blue light, the electronic cooling module 530 that adjusts a temperature of the first laser 117, the first case 410 that houses the first laser 117, and the second case 420 that houses the second laser 118 and the third laser 119.

Thus, only the first laser 117 forcibly cooled by the electronic cooling module 530 is housed in the first case 410. The first case 410 is small in size because the first case 410 houses only the first laser 117, separately from the second laser 118 and the third laser 119. The volume Vm of the moisture-proof space 411 (first storage space 411) for sealing against moisture can be made as small as possible, and thus, moisture prevention is easily achieved. The volume Vm of the moisture-proof space 411 is small, and thus, the force acting on the sealing member (not illustrated) due to internal pressure fluctuations caused by temperature changes is small, and the amount of water vapor remaining in the moisture-proof space 411 can be reduced.

As illustrated in FIG. 2, the second case 420 includes the moisture permeable portion 550 capable of transmitting water vapor.

Therefore, water vapor generated in the internal space 421 (second storage space 421) of the second case 420 can be dissipated to the outside through the moisture permeable portion 550. The amount of water vapor remaining in the second storage space 421 can be reduced.

As illustrated in FIG. 3, the first case 410 includes the transmissive portion 590 transmitting red light and being capable of enclosing the inside of the first case 410 (first storage space 411). The transmissive portion 590 is placed to transmit the red light and allow the red light to enter the second case 420 (the second storage space 421).

The first case 410 is enclosed by the transmissive portion 590 that transmits red light. Therefore, the inside 411 (the moisture-proof space 411, the first storage space 411) of the first case 410 can have a dust-proof and moisture-proof structure. Even though the first case 410 is configured to seal against moisture, the red light emitted from the first laser 117 housed in the inside 411 of the first case 410 can be efficiently emitted to the reflecting surface 120a of the first mirror 120.

As illustrated in FIG. 3, the second case 420 includes the dichroic mirror 120 (the first mirror 120) that combines the green light, the blue light, and the red light. The dichroic mirror 120 is placed on the optical path of the red light emitted from the transmissive portion 590, and is tilted with respect to the incident direction D3 of the red light. The direction RI in which the red light travels after being reflected by dichroic mirror 120 is defined as the first direction R1. The opposite direction R2 to the first direction R1 is defined as the second direction R2. The transmissive portion 590 is tilted with respect to the dichroic mirror 120 so that the end 592 in the first direction RI is spaced farther away than the end 593 in the second direction R2.

With a simple configuration in which the transmissive portion 590 is tilted with respect to the dichroic mirror 120, stray light caused by reflecting red light on the dichroic mirror 120 can be prevented as much as possible. As a result, it is possible for only light along the normal optical path to enter the light output interface 124 as much as possible.

As illustrated in FIG. 2, the light source module 100 further includes the first heat sink 560 that dissipates heat from the electronic cooling module 530, and the second heat sink 570 that dissipates heat from the second laser 118 and the third laser 119. The first heat sink 560 and the second heat sink 570 are placed with the gap Cr therebetween.

With the gap Cr between the first heat sink 560 and the second heat sink 570, heat transfer therebetween can be prevented, and as a result, each of the lasers 117 to 119 can be cooled efficiently.

As illustrated in FIG. 2, the light source module 100 further includes the air-cooling fan 580 that draws in the air Ar so that the air Ar flows through the second heat sink 570 and the first heat sink 560 in the stated order. The air-cooling fan 580 is provided on the end face 561 of the first heat sink 560 on the opposite side to the second heat sink 570.

If the air Ar is blown to the first and second heat sinks 560 and 570 using the air-cooling fan 580, the lasers 117 to 119 can be forcibly and efficiently cooled. In particular, the relatively large amount of heat generated by the first laser 117 can be forcibly and efficiently cooled by the electronic cooling module 530, the first heat sink 560, and the air-cooling fan 580. The second and third lasers 118 and 119 that generate less heat can be air-cooled first by the second heat sink 570 and the air-cooling fan 580, and then the first laser 117 that generates more heat can be air-cooled by the first heat sink 560 and the air-cooling fan 580. Therefore, all of the lasers 117 to 119 can be cooled more efficiently.

As long as the operations and effects of the present invention are exhibited, the present invention is not limited to the examples.

### INDUSTRIAL APPLICABILITY

The light source module 100 according to the present invention is suitable for use in a projection type display system mounted on a vehicle.

### REFERENCE SIGNS LIST

10 . . . Image display device
100 . . . Light source module
117 . . . First Laser
118 . . . Second Laser
119 . . . Third Laser
120 . . . Dichroic mirror (first mirror)
400 . . . Case
410 . . . First Case
411 . . . Internal space of first case (first storage space, moisture-proof space)
420 . . . Second Case
421 . . . Internal space of second case (second storage space)
530 . . . Electronic cooling module
550 . . . Moisture permeable portion
560 . . . First heat sink
561 . . . End face opposite to second heat sink
570 . . . Second heat sink
580 . . . Air-cooling fan
590 . . . Transmissive portion
592 . . . End in first direction
593 . . . End in second direction
Ar . . . Outside air (air)
Cr . . . Gap
D3 . . . Incident direction of red light
R1 . . . First direction
R2 . . . Second direction
Vm . . . Volume of first storage space (moisture-proof space)

1. A light source module comprising:
a first laser that emits red light;
a second laser that emits green light;
a third laser that emits blue light;
an electronic cooling module that adjusts a temperature of the first laser;
a first case that houses the first laser; and
a second case that houses the second laser and the third laser.

2. The light source module according to claim 1, wherein the second case includes a moisture permeable portion capable of transmitting water vapor.

3. The light source module according to claim 1, wherein
the first case includes a transmissive portion that transmits the red light and is capable of enclosing an inside of the first case, and
the transmissive portion is arranged to transmit the red light and allow the red light to enter the second case.

4. The light source module according to claim 3, wherein
the second case includes a dichroic mirror that combines the green light, the blue light, and the red light,
the dichroic mirror is placed on an optical path of the red light entering through the transmissive portion and is tilted with respect to an incident direction of the red light,
a direction in which the red light is reflected by the dichroic mirror and travels is defined as a first direction, and a direction opposite to the first direction is defined as a second direction, and
the transmissive portion is tilted with respect to the dichroic mirror such that an end in the first direction is spaced farther away than an end in the second direction.

5. The light source module according to claim 1, further comprising:
a first heat sink that dissipates heat from the electronic cooling module, and a second heat sink that dissipates heat from the second laser and the third laser, wherein
the first heat sink and the second heat sink are placed with a gap between the first heat sink and the second heat sink.

6. The light source module according to claim 5, further comprising:
an air-cooling fan that draws in air so that the air flows through the second heat sink and the first heat sink in the stated order, wherein
the air-cooling fan is provided on an end face of the first heat sink opposite to the second heat sink.
